(19) United States
(12) Patent Application Publication
(10) Pub. No.: US 2015/0049454 A1
(43) Pub. Date: Feb. 19, 2015

(54) VEHICLE INSTRUMENT PANEL EQUIPPED WITH A LIGHT SENSOR FOR DETECTING AN ILLUMINATED POINTER POSITION

(71) Applicant: DELPHI TECHNOLOGIES, INC., Troy, MI (US)

(72) Inventors: STEPHEN C. BLACKMER, MILLINGTON, MI (US); STEVEN A. LIBURDI, GROSSE POINTE FARMS, MI (US)

(21) Appl. No.: 13/965,710

(22) Filed: Aug. 13, 2013

(51) Int. Cl. B60Q 3/04

(52) U.S. Cl. CPC B60Q 3/046
USPC 362/23.02

(57) ABSTRACT

A vehicle instrument panel assembly configured to determine an orientation angle of an illuminated pointer of the assembly. The assembly includes a pointer, and a sensor. The pointer is configured to emit light and rotate about a display surface of the assembly to point to indicia on the display surface. The sensor is configured to detect light emitted by the pointer when the pointer is oriented at a predetermined orientation angle relative to the display surface.

### TECHNICAL FIELD OF INVENTION

This disclosure generally relates to vehicle instrument panel assembly, and more particularly relates to an assembly equipped with a sensor configured to detect light emitted by a pointer when the pointer is oriented at a predetermined orientation angle.

### BACKGROUND OF INVENTION

When vehicle instrument panel assemblies with traditional pointers are manufactured, a camera is used to determine any offset error between the actual pointer location and a desired pointer location corresponding to an indicia or grad on the display. This offset is programmed into the instrument panel to ensure that the offset is applied each time the instrument panel is powered. If power to the instrument panel is interrupted during normal operation, the instrument cluster does a “homing” operation to spin the pointer back to a zero position. As the pointer angle is unknown when power is applied, occasionally the motor will hit an internal hard-stop with enough force that motor drive bounces back out a step or two, and so the gauge becomes inaccurate.

### SUMMARY OF THE INVENTION

In accordance with one embodiment, a vehicle instrument panel assembly configured to determine an orientation angle of an illuminated pointer of the assembly is provided. The assembly includes a pointer, and a sensor. The pointer is configured to emit light and rotate about a display surface of the assembly to point to indicia on the display surface. The sensor is configured to detect light emitted by the pointer when the pointer is oriented at a predetermined orientation angle relative to the display surface.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a perspective view of a vehicle interior equipped with an instrument panel assembly in accordance with one embodiment;

FIG. 2 is a front view of the instrument panel of FIG. 1 in accordance with one embodiment; and

FIG. 3 is a side view of the instrument panel of FIG. 1 in accordance with one embodiment.

### DETAILED DESCRIPTION

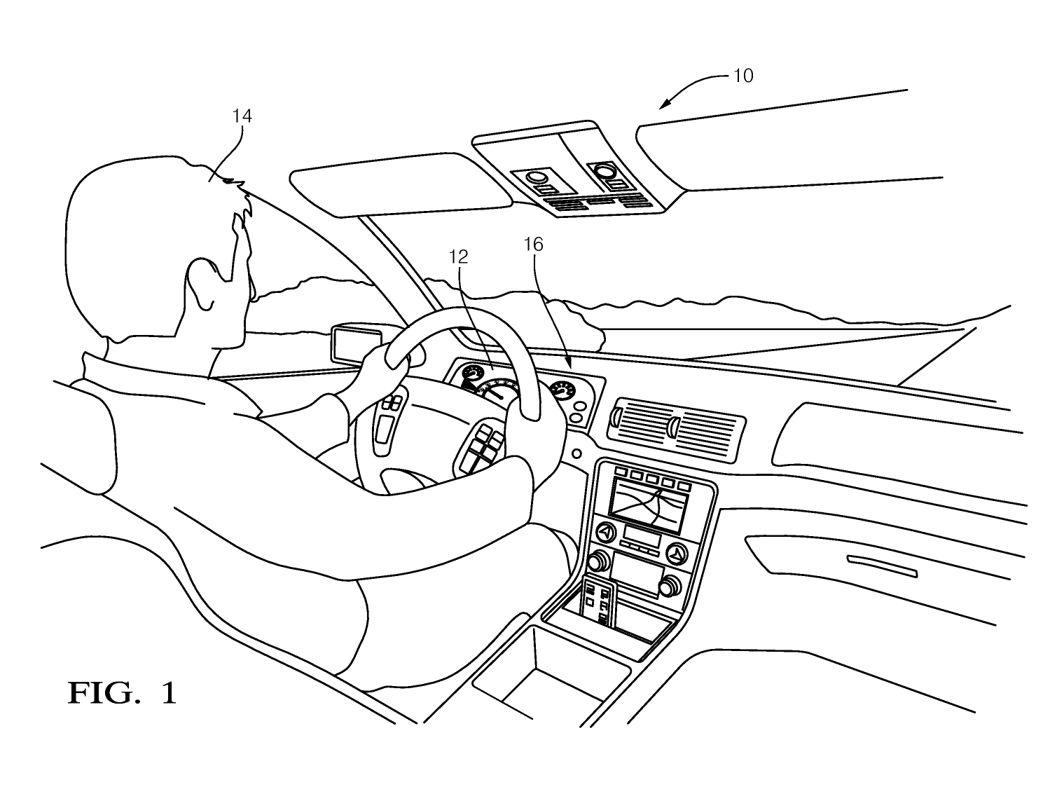

FIG. 1 illustrates a non-limiting example of a vehicle 10 equipped with an instrument panel assembly, hereafter referred to as the assembly 12, installed into a dashboard 16 of the vehicle 10. In general, the assembly 12 displays vehicle information to an operator 14 or operator of the vehicle 10 such as vehicle speed, engine coolant temperature, and the like.

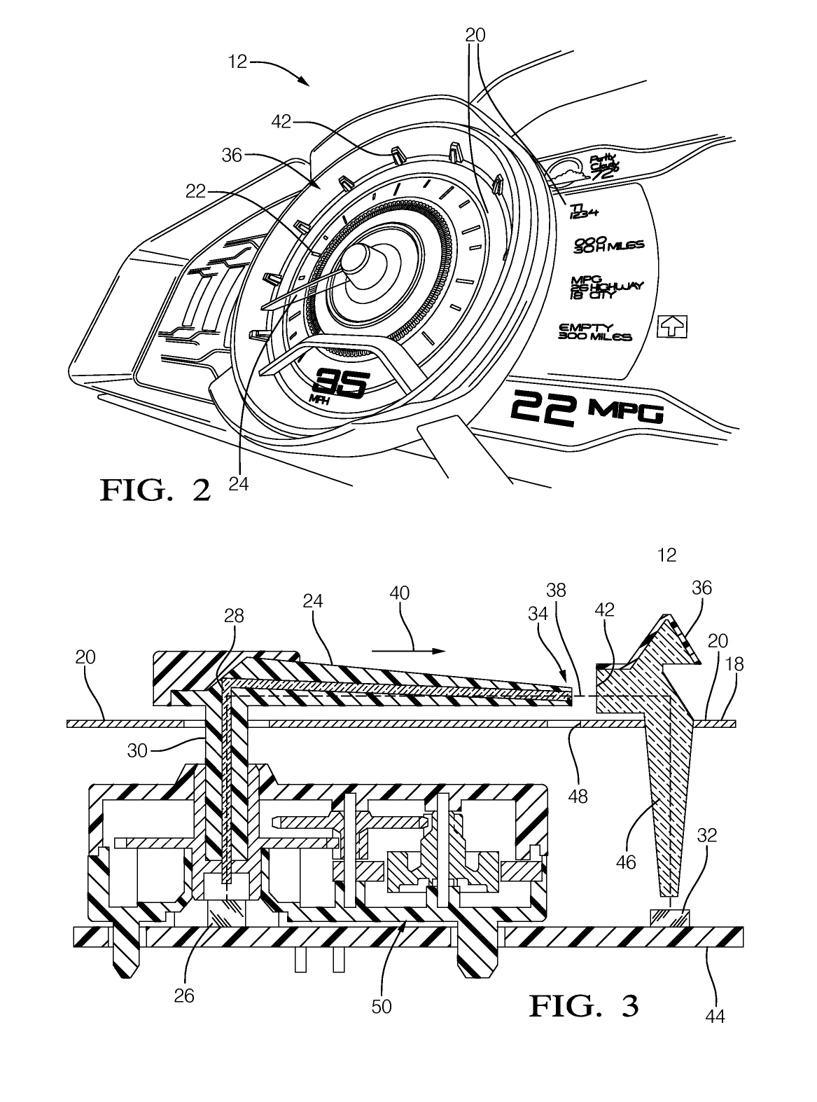

FIGS. 2 and 3 illustrate a non-limiting examples of portions of the assembly 12 in more detail than shown in FIG. 1. In general, the assembly 12 includes an applique 18 that defines a display surface 20 of the assembly 12. In this example the applique 18 spans most of the viewing area of the assembly 12. The applique 18 typically includes graphics and indicia 22 that determine the appearance of an instrument panel (the assembly 12). Some of the indicia 22 may be configured to become visibly apparent to the operator 14 only when suitably backlit.

The assembly 12 includes a pointer 24 operable to move about an axis or rotate about the display surface 20 of the assembly 12 to point to the indicia 22 on the display surface 20. In general, the pointer 24 is configured to emit light so the pointer 24 is easily seen by the operator 14. As such, the pointer 24 may be characterized as an illuminated pointer. Various methods of providing an illuminated pointer are known, as will be recognized by those in the art. By way of example and not limitation, the pointer 24 described herein may be formed mostly of transparent material such as a clear polymeric compound so that the pointer 24 can be illuminated by a light source 26 configured to project light 28 into a shaft portion 30 of the pointer 24.

In general, the assembly 12 is configured to determine an orientation angle of the pointer 24 relative to the display surface 20. In other words, the assembly 12 may be configured to determine when the pointer 24 is at some predetermined orientation angle relative to the display surface. For example, determine when the pointer 24 is pointing toward one of the indicia 22 that corresponds to thirty five miles per hour (35 mph). By way of example and not limitation, the assembly 12 may include a sensor 32 configured to detect light emitted by the pointer 24 when the pointer 24 is oriented at an orientation angle that corresponds to thirty five miles per hour (35 mph). In addition to radiating light so the pointer 24 appears to be illuminated to the operator 14, a tip 34 of the pointer 24 may have a shape and/or features that help to project some of the light 28 toward the sensor 32.

In one embodiment, the assembly 12 may include a trim ring 36 configured to direct light 28 emitted by the pointer 24 toward the sensor 32 when the pointer 24 is oriented at the predetermined orientation angle. For example, the trim ring 38 may be specifically configured to direct light 38 emitted in a radial direction 40 by the pointer 24 toward the sensor 32. Such a configuration may include forming the trim ring 36 of a clear polymeric compound, coating the surface of the trim ring 36 with an opaque coating that prevents light from entering the trim ring 36 except for a clear section 42 that allows light 38 from the pointer 24 to enter the trim ring 36 when the pointer 24 is aligned with the clear section as illustrated in FIG. 3.

If the sensor 32 is located relatively remote from the display surface 20, for example mounted on a printed circuit board 44 under the display surface 20 and spaced apart from the applique 18, then assembly 12 may include a light pipe 46 that may be integral to the trim ring 36 and configured to direct light 38 emitted by the pointer 24 from the display surface 20 to the sensor 32.

Alternatively, the tip 34 may have a beveled end (not shown) or a reflective device (not shown) configured to project light downward through an opening 48 in the applique 18 so that an alternative sensor (not shown) located proximate to the opening 48 could detect light emitted by the pointer 24 when the pointer 24 was aligned over the opening 48.

While the non-limiting example suggests that only one sensor is used and so the pointer 24 can only be detected at one orientation angle, it is recognized that a plurality of sensors could be used to determine that the pointer is at any one of a plurality of predetermined orientation angles. Knowledge of the orientation angle of the pointer 24 at any instant in time may be useful to check for pointer positioning errors due to some malfunction of, for example, a stepper motor 50 used to control the position or orientation angle of the pointer 24.

The assembly may include a controller (now shown) in electrical communication with the sensor 32 and the stepper motor assembly 50. The controller may include a processor such as a microprocessor or other control circuitry as should be evident to those in the art. The controller may include memory, including non-volatile memory, such as electrically erasable programmable read-only memory (EEPROM) for storing one or more routines, thresholds and captured data. The one or more routines may be executed by the processor to perform steps for determining if signals received by the controller indicate that the pointer 24 is at the orientation angle it is expected to be.

Accordingly, a vehicle instrument panel assembly (the assembly 12) configured to determine an orientation angle of an illuminated pointer (the pointer 32) of the assembly 12 is provided. Being able to determine the orientation angle of the pointer 32 is useful to prevent errors in the event of, for example, a momentary power loss, and/or the stepper motor 50 loosing track of motor position because the pointer 24 struck a hard stop of the assembly 12.

While this invention has been described in terms of the preferred embodiments thereof, it is not intended to be so limited, but rather only to the extent set forth in the claims that follow.

We claim:

1. A vehicle instrument panel assembly configured to determine an orientation angle of an illuminated pointer of the assembly, said assembly comprising:
a pointer configured to emit light and rotate about a display surface of the assembly to point to indicia on the display surface; and
a sensor configured to detect light emitted by the pointer when the pointer is oriented at a predetermined orientation angle relative to the display surface.

2. The assembly in accordance with claim 1, wherein the assembly includes a trim ring configured to direct light emitted by the pointer toward the sensor when the pointer is oriented at the predetermined orientation angle.

3. The assembly in accordance with claim 2, wherein the trim ring is configured to direct light emitted in a radial direction by the pointer toward the sensor.

4. The assembly in accordance with claim 2, wherein the sensor is located under the display surface, and the trim ring includes a light pipe configured to direct light emitted by the pointer from the display surface to the sensor.
